(19) United States
(12) Patent Application Publication
(10) Pub. No.: US 2008/0263051 A1
(43) Pub. Date: Oct. 23, 2008

(54) SYSTEM FOR MANAGEMENT OF A PROFESSIONAL EMPLOYMENT ORGANIZATION USING BEST SUITED HETEROGENEOUS SYSTEMS

(75) Inventors: Michael J. Kanyetzny, Brooklyn Center, MN (US); Leslie D. Schuhbauer, Brooklyn Center, MN (US)

Correspondence Address: SCHWEGMAN, LUNDBERG & WOESSNER, P.A., P.O. BOX 2938, MINNEAPOLIS, MN, 55402, US

(73) Assignee: TRANSPORT LABOR CONTRACT/LEASING INC., BROOKLYN CENTER, MN (US)

(21) Appl. No.: 11/738,289

(22) Filed: Apr. 20, 2007

(51) Int. Cl. G06F 17/30

(52) U.S. Cl. 707/10; 707/E17.117

(57) ABSTRACT

According to one example embodiment, the inventive subject matter herein provides a system that integrates a plurality of heterogeneous systems in support of a Professional Employment Organization (PEO). According to one example embodiment, the system of the inventive subject matter connects a plurality of heterogeneous systems using a shared data store in the form of a data web. The systems may share data through the data web to provide a variety of functions to support the PEO, wherein the functions are supported by the heterogeneous systems. An interface system is provided to provide access to the functions of the heterogeneous systems, wherein the interface provides a homogenous view of the heterogeneous systems and functions.

### TECHNICAL FIELD

The technology of the inventive subject matter described herein relates generally to information systems and more particularly to an enterprise management system.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2007, Transport Labor Contract/Leasing, Inc. All Rights Reserved.

### BACKGROUND

Professional Employment Organizations (PEOs) are businesses that help other businesses with the legal and administrative risks and responsibilities of being an employer. The defining trait of PEOs over other businesses, such as payroll administrators or insurance companies that may offer employment or human resource related services, is that PEOs contractually act as joint- or co-employers for employees of their client businesses. Specifically, a PEO takes on some of the legal risks and obligations of an employer for the employees of its client businesses.

Typically, the responsibilities are divided such that the PEO is responsible for providing and administering workers compensation insurance, unemployment insurance, health insurance, disability insurance, social security, and income taxes as well as administering payroll and conducting background checks. PEO clients, on the other hand, are responsible for recruiting, validating ability, assigning, supervising, and managing the daily work of their employees and generally making hiring and firing decisions.

From a client perspective, a key benefit of using PEOs is that it allows clients to focus on their core business, while also redeploying the administrative expense of being an employer to growth or productivity enhancing activities, thereby improving profits for the PEO clients. Although almost any industry can or has benefited from the use of PEOs, the trucking industry has been particularly receptive to use of PEOs.

### SUMMARY

According to one example embodiment, the inventive subject matter herein provides a system that integrates a plurality of heterogeneous systems in support of a PEO. According to one example embodiment, the system of the inventive subject matter connects a plurality of heterogeneous systems using a shared data store in the form of a data web. The systems may share data through the data web to provide a variety of functions to support the PEO, wherein the functions are supported by the heterogeneous systems. An interface system is provided to provide access to the functions of the heterogeneous systems, wherein the interface provides a homogenous view of the heterogeneous systems and functions.

### BRIEF DESCRIPTION OF THE DRAWING

FIGS. 1A through 1N illustrate a system for integrating heterogeneous systems in support of a PEO, according to one example embodiment of the inventive subject matter disclosed herein;

FIG. 2 illustrates an interface system for the system of FIG. 1, according to one example embodiment of the inventive subject matter disclosed herein; and

FIG. 3 illustrates a diagram of one example embodiment of a computing system architecture, according to the inventive subject matter disclosed herein.

### DETAILED DESCRIPTION

In the following detailed description, reference is made to the accompanying drawings that form a part hereof, and in which are shown, by way of illustration, specific embodiments in which the inventive subject matter can be practiced. It is understood that other embodiments may be utilized and structural changes may be made without departing from the scope of the inventive subject matter. The leading digit(s) of reference numbers appearing in the Figures generally corresponds to the Figure number in which that component is first introduced, such that the same reference number is used throughout to refer to an identical component which appears in multiple Figures. Signals and connections may be referred to by the same reference number or label, and the actual meaning will be clear from its use in the context of the description.

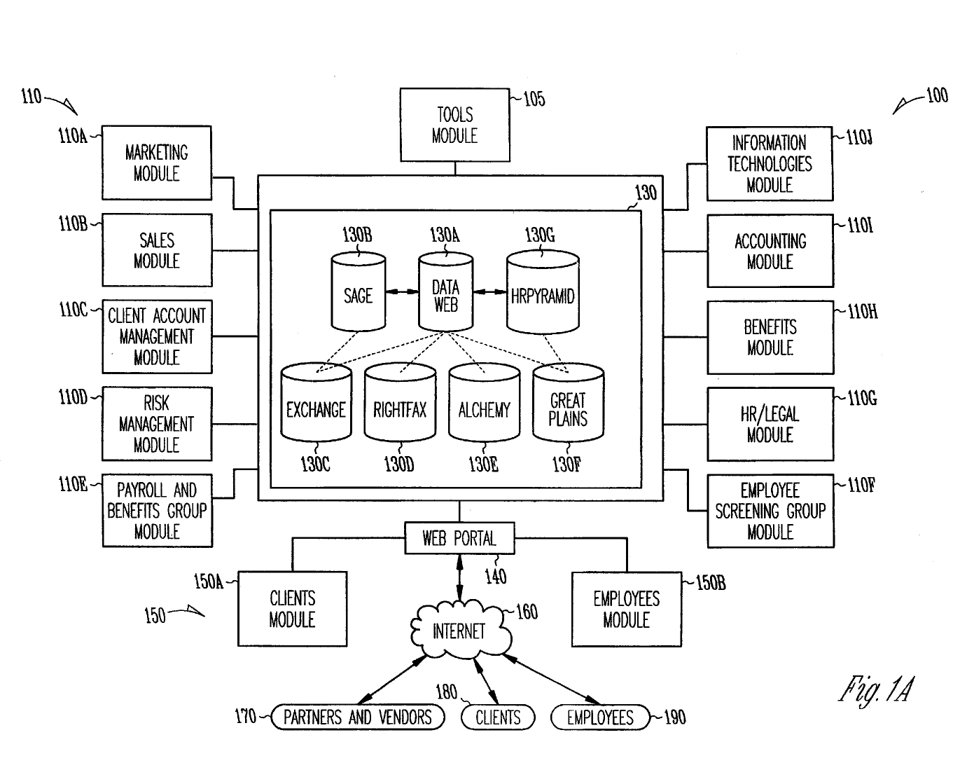

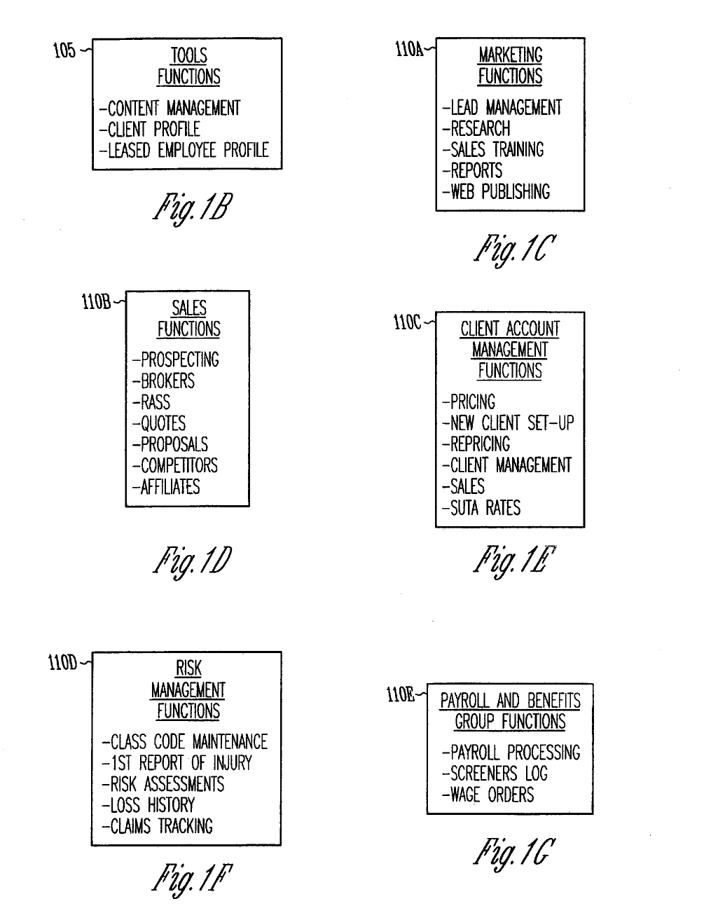

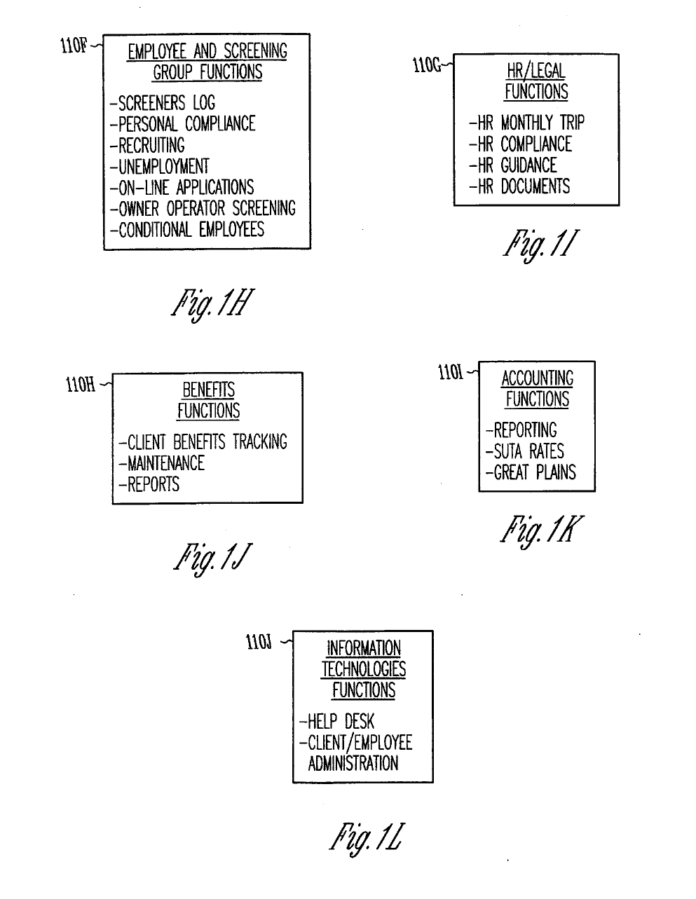

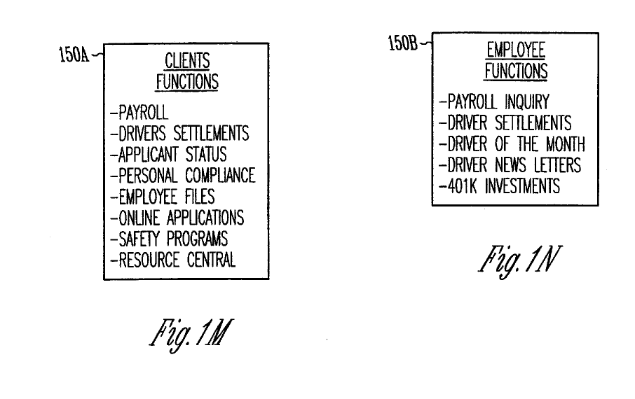

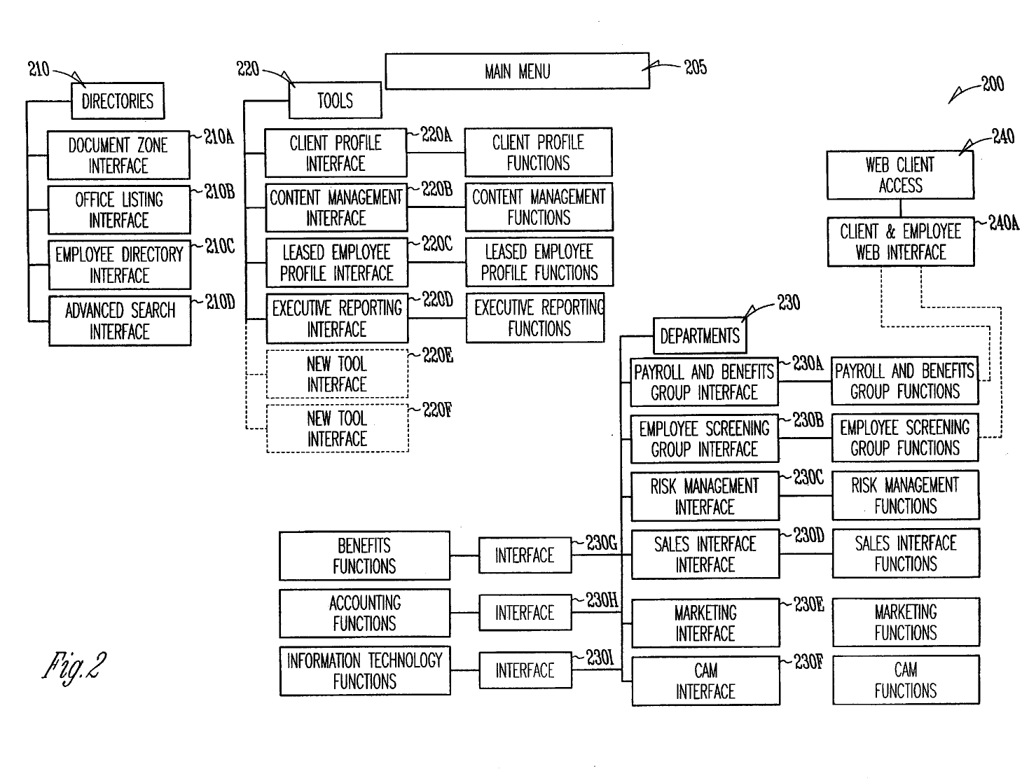

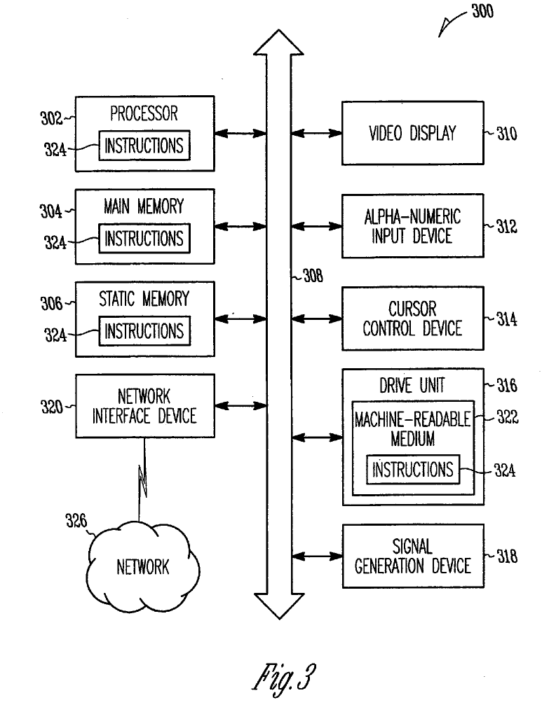

Referring now to FIG. 1A, there is illustrated a functional diagram of one example embodiment of a system 100, wherein a plurality of heterogeneous systems, for example the systems best suited for support of the PEO, such as best of breed systems, are integrated for support of a PEO. According to one example embodiment, system 100 automates and integrates PEO systems used to process a new PEO client and maintain the activities of existing PEO clients. System 100 further provides a total view of a client's activities, value, and costs, from the time of being a prospect to termination. Further, system 100 facilitates automating system and workflow interfaces between all the critical PEO business systems, and provides clients access to their information through a secured web portal interface.

Accordingly, system 100 combines all business information needs together into a single system enabling all departments and facilities or offices of a PEO to share information and communicate standard and critical business events in a real time environment. The capabilities or functions of the system 100 allow a management team to see all the critical client data and daily events as they occur so they may be able to respond to an issue before it becomes critical. Still further, according to one embodiment, system 100 is designed to allow users to maintain the master data in one database and the other systems to use the same data without re-entering that data into the other system. In another example embodiment, system 100 uses industry standard tools and is designed to be flexible and scaleable to allow the business to add new modules, business workflows, or enhancements without the need to re-write the entire system.

To achieve these objectives and others, the system 100 supports various computerized functions that are accessed through tools module 105, department modules 110, individually labeled 110a through 110j, and web portal modules 150, labeled 150a and 150b. Modules 110 include a Marketing module 110a, a Sales module 110b, a Client Account Management (CAM) module 110c, a Risk Management module 110d, a Payroll and Benefits Group module 110e, a Employee Screening Group module 110f, an HR/Legal module 110g, a Benefits module 110h, an Accounting module 110i, and an Information Technology Module 110j.

Web portal 140 provides access to the Clients module 150a, Employees module 150b, for partners and vendors 170, clients 180, and employees 190. Functions are supported from computing systems 130, using a centralized data store 130a. In one embodiment, system 100 has a open architecture that provides the capabilities for automated data functions between the critical PEO computing systems 130. According to such an embodiment, for example, data store 130a is a main database that maintains departmental information and is integrated with other PEO core systems 130a through 130g, including a business process management system, such as SAGE 130b, an e-mail server, such as for example Exchange Server 130c, a Fax server, such as, for example, RightFax 130d, a document imaging system (used to store the employee files and DOT information for each work site employee) such as, for example, Alchemy 130e, an accounting system, such as, for example, Great Plains 130f, and an human resources (HR) management system, such as, for example, HRPyramid 130g.

Systems 130a through 130g may each be obtained from a different software provider and, in one embodiment, are selected according to which one is best suited to the needs of the PEO to support the corresponding functions. As such, these systems are not intrinsically integrated, such as may be obtained where an enterprise management system provided by a single vendor may integrate the functions of one or more of the systems 130a through 130g without any integration required by the customer. On the other hand, the system of the present subject matter is designed to allow non-intrinsically integrated heterogeneous systems, such as those described herein, to be functionally integrated. Thus, as used herein, the term “heterogeneous systems” refers to systems that are not intrinsically integrated and provide a diverse set of functionalities, respectively.

Referring now to FIG. 1B, the Tools module 105 may be made available to all users, and includes a Client profile function, Content Management function, and a Leased Employee Profile function.

As illustrated in FIG. 1C, the Marketing module 110a includes a Lead Management function, a Research function, a Sale Tracking function, a Reports function and a Web Publishing function.

As illustrated in FIG. 1D, the Sales module 110b includes a Sales Prospecting function, a Brokers function, a RASS function, a Quotes function, a Proposals function, a Competitor Profile function, and an Affiliate Profile function.

As illustrated in FIG. 1E, the Client Account Management (CAM) module 110c includes a Pricing function, a New Client Set-up function, a Repricing function, a Client Management function, a Sales Management function, and a SUTA Rates function.

As illustrated in FIG. 1F, the Risk Management module 110d includes a Class Code Maintenance function, a 1^{st} Report of Injury function, a Risk Assessment (RASS) function, a Loss History function, and a Claims Tracking function.

As illustrated in FIG. 1G, Payroll and Benefits Group module 110e includes a Payroll Processing function, a Screeners Log function, and a Wage Orders function.

As illustrated in FIG. 1H, Employee Screening Group module 110f includes a Screeners Log function, a Personal Compliance function, a Recruiting function, an Unemployment function, an On-Line Applications function, an Owner Operator Screening function and a Conditional Employees function.

As illustrated in FIG. 1I, the HR/Legal module 110g includes functions HR Monthly Trip, HR Compliance, HR Guidance and HR Documents.

As illustrated in FIG. 1J, the Benefits module 110h includes a Client Benefits Tracking function, a Maintenance function, and a Reports function.

As illustrated in FIG. 1K, the Accounting module 110i includes a Reporting function, a SUTA Rates function, and a Great Plains access function.

As illustrated in FIG. 1L, the Information Technology module 110j includes a Help Desk function, and a Client/Employee Administration function.

As illustrated in FIG. 1M, the Clients module 150a provides client with up-to-date real time information from the various PEO departments from the portal or specific email alerts and messages from PEO. The functions provided by module 150a include a Payroll function, a Drivers Settlements function, an Applicant Status function, a Personal Compliance function, an Employee Files function, an Online Applications function, a Safety Programs function and a Resource Central function. Further functions that may be provided by module 150a include an a Payroll Processing function, a Payroll Inquiry function, a Document function, a Forms function, and an Owner Operator Screening function.

As illustrated in FIG. 1N, the Employee module 150b provides a Payroll Inquiry function, a Driver Settlements function, a Driver of the Month function, a Driver News Letters function, and a 401K investments function.

Referring to the diagram of FIG. 2, an interface menu 200 provides access to the functions described above with respect to FIG. 1, and for a number of additional capabilities. A main menu 205 functions as the company's main information page that all users access to view current company messages and announcements. A Directories interface 210 may be made available to all users, and provides a Document Zone interface 210a, an Office Listing interface 210b, an Employee Listing interface 210c, and an Advanced Search interface 210d, all providing access to corresponding functions or data.

A Tools interface 220 may be made available to all users, and provides access to the functions provided by the Tools module 105. The interface 220 includes a Client profile interface 220a to Client profile functions, Content Management interface 220b to Content Management functions or documents, a Leased Employee Profile interface 220c to Leased Employee Profile functions, and an Executive Reporting interface 220d to Executive Reporting functions.

A Departments interface 230 provides interfaces for various functions provided by the department modules 110a to 110j. Payroll and Benefits Group interface 230a provides access to the functions of Payroll and Benefits Group module 110e. Employee Screening Group interface 230b provides access to the functions of Employee Screening Group module 110f. A Risk Management interface 230c provides access to Risk Management functions available from the Risk Management module 110d. Sales interface 230d provides access to the functions provided by the Sales Module 110b. A Marketing interface 230e provides access to the functions provided by the Marketing Module 110a. A CAM interface 230f provides access to the functions provided by the CAM Module 110c. A Benefits interface 230g provides access to the functions provided by the Benefits Module 110h. An Accounting interface 230h provides access to functions of the Accounting Module 110i. An Information Technology interface 230i provides access to the functions of the Information Technology Module 110j.

A Web site interface 240 is accessed by clients or employees as a secured portal, represented as portal 140 in FIG. 1, to the specific information and services they are using. These services 240a provide access to the functions provided by the Client Module 150a and/or Employee Module 150b.

FIG. 3 shows a diagrammatic representation of a machine in the example form of a computer system 300 within which a set of instructions 324, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 300 includes a processor 302 (e.g., a central processing unit (CPU), a graphics processing unit (GPU), or both), a main memory 304, and a static memory 306, which communicate with each other via a bus 308. The computer system 300 may further include a video display unit 310 (e.g., a liquid crystal display (LCD) or a cathode ray tube (CRT)). The computer system 300 also includes an alphanumeric input device 312 (e.g., a keyboard), a cursor control device 314 (e.g., a mouse), a disk drive unit 316, a signal generation device 318 (e.g., a speaker), and a network interface device 320. The disk drive unit 316 includes a machine-readable medium 322 on which is stored one or more sets of instructions and data structures (e.g., software) 324 embodying or utilized by any one or more of the methodologies or functions described herein. The instructions 324 may also reside, completely or at least partially, within the main memory 304 and/or within the processor 302 during execution thereof by the computer system 300, the main memory 304, and the processor 302 also constituting machine-readable media. The instructions 324 may further be transmitted or received over a network 326 via the network interface device 320 utilizing any one of a number of well-known transfer protocols, for example the hyper text transfer protocol (HTTP).

While the machine-readable medium 322 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any one or more of the methodologies of the present invention, or that is capable of storing, encoding, or carrying data structures utilized by, or associated with, such a set of instructions. The term “machine-readable medium” shall accordingly be taken to include, but not be limited to, solid-state memories, optical and magnetic media, and carrier wave signals.

Accordingly, the system according to the inventive subject matter allows a plurality of heterogeneous systems, for example the systems best suited for support of the PEO, to be integrated for support of a PEO. According to one example embodiment, the system automates and integrates PEO systems used to process a new PEO client and maintain the activities of existing PEO clients. The system further provides a total view of a client's activities, value, and costs, from the time of being a prospect to termination. Further, the system facilitates automating system and workflow interfaces between all the critical PEO business systems, and provide clients access to their information through a secured web portal interface. Thus, the system combines all business information needs together into a single system enabling all departments and facilities or offices of a PEO to share information and communicate standard and critical business events in a real time environment. The capabilities or functions of the system thus allow a management team to see all the critical client data and daily events as they occur so they may be able to respond to an issue before it becomes critical. Still further, according to one embodiment, the system is designed to allow users to maintain the master data in one database and the other systems to use the same data without re-entering that data into the other system. In another example embodiment, the system may use industry standard tools and is designed to be flexible and scaleable to allow the business to add new modules, business workflows or enhancements without the need to re-write the entire system.

In this description, numerous specific details are set forth. However, it is understood that embodiments of the invention may be practiced without these specific details. In other instances, well-known circuits, software, structures, and techniques have not been shown in detail in order not to obscure the understanding of this description. Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the inventive subject matter can include any variety of combinations and/or integrations of the embodiments described herein. Each claim, as may be amended, constitutes an embodiment of the invention, incorporated by reference into the detailed description. Moreover, in this description, the phrase “exemplary embodiment” means that the embodiment being referred to serves as an example or illustration. Further, block diagrams illustrate exemplary embodiments of the invention. Also herein, flow diagrams illustrate operations of the exemplary embodiments of the invention. The operations of the flow diagrams are described with reference to the exemplary embodiments shown in the block diagrams. However, it should be understood that the operations of the flow diagrams could be performed by embodiments of the invention other than those discussed with reference to the block diagrams, and embodiments discussed with reference to the block diagrams could perform operations different than those discussed with reference to the flow diagrams. Still further, processes referred to herein that may be carried out on a computer system shall be understood to be implemented, for example, but not by way of limitation, in software or hardware, or a combination thereof. Additionally, some embodiments may not perform all the operations shown in a flow diagram. Moreover, it should be understood that although the flow diagrams depict serial operations, certain embodiments could perform certain of those operations in parallel.

What is claimed is:

1. A system, comprising:
a plurality of heterogeneous systems connected to a central data store;
wherein the heterogeneous systems support a Professional Employment Organization (PEO) and the central data store stores PEO data from each of the heterogeneous systems, wherein the PEO data relates to the operation of the PEO;
wherein the heterogeneous systems include at least one content management system, at least one e-mail server, at least one accounting system, at least one human resources (HR) management system, at least one sales support system, at least one client account management system, and at least one risk management system;
wherein the heterogeneous systems support at least all of the following functions: content management, lead management, lead research, sales training, prospecting, pricing and quotes, proposal preparation, new client set up, repricing, client management, class code maintenance, 1^{st} report of injury, risk assessments, loss history, claims tracking, payroll processing, screeners log, wage orders, personal compliance, recruiting, unemployment, on-line applications, owner operator screen, accounting and client benefits;
a common interface to provide access to the functions supported by the heterogenous systems, wherein the common interface allows a plurality of different PEO employee groups to access functions of the heterogeneous systems that are needed by the employee groups; and
a web portal to provide access to clients of the PEO, wherein the clients may access at least all the following functions: payroll inquiry, employee settlements, newsletters, retirement investments, applicant status, personal compliance, employee files, online applications, and safety programs.

2. A system, comprising:
a plurality of heterogeneous systems connected to a central data store;
wherein the heterogeneous systems support a Professional Employment Organization (PEO) and the central data store stores PEO data from each of the heterogeneous systems, wherein the PEO data relates to the operation of the PEO;
wherein the heterogeneous systems include at least one content management system, at least one e-mail server, at least one accounting system, at least one human resources (HR) management system, at least one sales support system, at least one client account management system, and at least one risk management system;
a common interface to provide access to functions supported by the heterogenous systems, wherein the common interface allows a plurality of different PEO employee groups to access the functions of the heterogeneous systems that are needed by the employee groups; and
a web portal to provide access to the PEO data in the central data store to clients of the PEO, wherein the clients may access at least all the following functions: payroll inquiry, employee settlements, newsletters, retirement investments, applicant status, personal compliance, employee files, online applications, and safety programs.

3. A method, comprising:
connecting a plurality of heterogeneous systems to a central data store;
storing Professional Employment Organization (PEO) data in the central data store, wherein the PEO data is processed at least in part on at least one of the heterogeneous systems, wherein the PEO data relates to the operation of the PEO;
wherein the heterogeneous systems include at least one content management system, at least one e-mail server, at least one accounting system, at least one human resources (HR) management system, at least one sales support system, at least one client account management system, and at least one risk management system;
PEO employees accessing functions supported by the heterogeneous systems through a common interface; and
clients of the PEO accessing PEO data through a web portal accessing data in the central data store, wherein the clients may access at least all the following functions: payroll inquiry, employee settlements, newsletters, retirement investments, applicant status, personal compliance, employee files, online applications, and safety programs.
